(19) United States
(12) Patent Application Publication
(10) Pub. No.: US 2023/0175772 A1
(43) Pub. Date: Jun. 8, 2023

(54) METHOD FOR SUPPLEMENTING CONDENSER HEAT REJECTION IN NATURAL GAS PROCESSING

(71) Applicant: GTUIT, LLC, Billings, MT (US)

(72) Inventors: Mark Peterson, Helena, MT (US); James L. Haider, Helena, MT (US); Brian R. Cebull, Billings, MT (US); Austin Vandelinder, Billings, MT (US); Jackson Haider, Billings, MT (US); Stephen Doll, Big Arm, MT (US)

(21) Appl. No.: 17/983,686

(22) Filed: Nov. 9, 2022

Related U.S. Application Data
(60) Provisional application No. 63/286,059, filed on Dec. 5, 2021.

(51) Int. Cl. F25J 1/00; F25J 3/02

(52) U.S. Cl. CPC F25J 1/0022; F25J 3/0209; F25J 2270/02

(57) ABSTRACT

A method for supplementing condenser heat rejection in natural gas processing including passing unprocessed gas through a gas-to-chilling fluid heat exchanger, transferring cooled and condensed gas to a vapor liquid separator, sending the chilling fluid to a chilling fluid reservoir, directing the chilling fluid to a refrigeration sub-system, circulating refrigerant throughout the refrigeration sub-system, touting vapor refrigerant through a refrigeration compressor, sending the vapor refrigerant to a refrigeration condenser, routing the liquid refrigerant to an accumulator tank and through an expansion valve, muting the reduced-pressure liquid refrigerant to the evaporator, and passing at least a portion of the processed vapor to a processed vapor-to-refrigerant heat exchanger via an actuated valve controlled by a processor to remove heat from the liquid refrigerant before the liquid refrigerant is sent to the expansion valve. The refrigeration sub-system includes an evaporator that is configured to transfer heat from the chilling fluid to the refrigerant.

### CROSS-REFERENCE TO RELATED APPLICATION

Pursuant to 35 U.S.C. § 119(e), this application claims the benefit of U.S. Patent Application No. 63/286,059. filed on Dec. 5, 2021.

### BACKGROUND OF THE INVENTION

### 1. Field of the Invention

The present invention relates generally to the field of oil and gas production, and more particularly, to a method for supplementing condenser heat rejection in the contest of natural gas processing.

### 2. Description of the Related Art

In the oil and gas industry, refrigeration is used to effectively remove natural gas liquids (NGLs) from high Btu gas. or gas rich with heavy hydrocarbons. Heavy hydrocarbons, defined as hydrocarbons with carbon chains longer than two carbons, arc often removed for dew pointing, engine fueling, and many other applications. To remove heavy hydrocarbons from natural gas streams, a common industry practice is to manipulate the vapor-liquid equilibrium of the gas by varying temperature and pressure so that the heavy hydrocarbons condense and form NGLs and the light hydrocarbons remain a vapor. Once the heavy hydrocarbons and light hydrocarbons of the natural gas stream are in different stares of matter, they can be more easily separated by mechanical methods.

A refrigeration cycle is often used to manipulate the temperature of natural gas in a natural gas processing system. The energy required to cool and condense gaseous hydrocarbons into the liquid phase is the heat load on the refrigeration cycle. This heat load is transferred to the refrigerant through a heat exchanger commonly referred to as an evaporator. The evaporator uses the latent heat of vaporization to absorb the beat load into the refrigerant as it changes state from a liquid to a vapor. The heat toad is then rejected through a heat exchanger commonly referred to as a condenser. The condenser uses the latent heat of condensation to reject the heat load as the refrigerant changes state from a vapor to a liquid. The condenser utilizes a fluid medium that absorbs the heat load and then exits the natural gas processing system. This allows for the continuous energy transfer from the natural gas stream entering the system to a fluid medium exiting the system.

It is common industry practice to use ambient air as the fluid medium to which the condenser transfers the heat load from the refrigeration cycle. The efficiency of heat transfer between ambient air and the system's refrigerant at the condenser is directly proportional to the temperature difference between these two fluid mediums. In practice, the ambient air temperature may rise to a point at which the desired amount of energy is not being fully transferred out of the system through the condenser, thereby limiting the heat load that can be removed from the natural gas. Such a system is often referred to as a condenser-limited system. A condenser-limited system may reduce the efficiency of NGL separation from a natural gas stream for systems that rely on refrigeration to accomplish phase change. Traditional methods of mitigating condenser limitations on a refrigeration cycle are expensive, may require outside processing, and increase the physical footprint of the system.

### BRIEF SUMMARY OF THE INVENTION

The present invention is a method for supplementing condenser heat rejection in natural gas processing comprising the steps of: passing unprocessed gas through a gas-to-chilling fluid heat exchanger to generate cooled and condensed gas, wherein the gas-to-chilling fluid heat exchanger contains chilling fluid; transferring the cooled and condensed gas to a vapor liquid separator to generate a first stream of processed liquids and a second stream of processed vapor: allowing the chilling fluid to exit the gas-to-chilling fluid heat exchanger and enter a chilling fluid reservoir; directing the chilling fluid to a refrigeration sub-system via a chilling fluid pump; wherein the refrigeration sub-system comprises an evaporator that is configured to transfer heat from the chilling fluid to a refrigerant, thereby generating vapor refrigerant; circulating the refrigerant throughout the refrigeration sub-system; routing the vapor refrigerant through a refrigeration compressor: sending the vapor refrigerant to a refrigeration condenser that is configured to transfer heat load from the vapor refrigerant to atmosphere and to condense the vapor refrigerant into a liquid, thereby generating liquid refrigerant; routing the liquid refrigerant to an accumulator tank; routing the liquid refrigerant through an expansion valve that is configured to reduce temperature and pressure of the liquid refrigerant to generate reduced-pressure liquid refrigerant; routing the reduced-pressure liquid refrigerant to the evaporator; and passing at least a portion of the processed vapor to a processed vapor-to-refrigerant heat exchanger via an actuated valve controlled by a processor to remove heat from the liquid refrigerant before the liquid refrigerant is sent to the expansion valve.

In a preferred embodiment, the present invention further comprises the steps of: monitoring temperature anti pressure of the refrigerant downstream of the compressor and upstream of the expansion valve via the processor; monitoring temperature of the cooled and condensed gas via the processor: wherein the compressor has a speed, adjusting the speed of the compressor in real-time via the processor based on input from the previous; and wherein lite refrigeration condenser has a condenser fan, adjusting the speed of the condenser fan in real-time via the processor based on input from the previous steps.

The present invention is also a method for supplementing condenser heat rejection in natural gas processing comprising the steps of: providing a stream of natural gas: directing the natural gas to a refrigeration sub-system: wherein the refrigeration sub-system comprises an evaporator that is configured to transfer heat from the natural gas to a refrigerant, thereby generating vapor refrigerant and cooled and condensed natural gas; transferring the cooled and condensed gas to a vapor liquid separator to generate a first stream of processed liquids and a second stream of processed vapor: circulating the refrigerant throughout the refrigeration sub-system: routing the vapor refrigerant through a refrigeration compressor; sending the vapor refrigerant to a refrigeration condenser that is configured to transfer heat load from the vapor refrigerant to atmosphere and to condense the vapor refrigerant into a liquid, thereby generating liquid refrigerant; routing the liquid refrigerant to an accumulator tank; routing the liquid refrigerant through an expansion valve that is configured to reduce temperature and pressure of the liquid refrigerant to generate reduced-pressure liquid refrigerant; routing the reduced-pressure liquid refrigerant to the evaporator; and passing at least a portion of the processed vapor via an actuated valve controlled by a processor to a processed vapor-to-refrigerant heat exchanger to remove heat font the liquid refrigerant before the liquid refrigerant is sent to the expansion valve.

In a preferred embodiment, the present invention further comprises the steps of: monitoring temperature and pressure of the refrigerant downstream of the compressor and upstream of the expansion valve via the processor; monitoring temperature of the cooled and condensed gas via the processor; wherein the compressor has a speed, adjusting the speed of the compressor in real-time via the processor based on input from the previous steps; and wherein the refrigeration condenser has a condenser fan, adjusting the speed of the condenser fen in real-time via the processor based on input from the previous steps.

The present invention is also a method for supplementing condenser heat rejection in natural gas processing comprising the steps of: passing unprocessed gas through a gas-to-chilling fluid heat exchanger to generate cooled and condensed gas, wherein the gas-to-chilling fluid heat exchanger contains chilling fluid; transferring the cooled and condensed gas to a vapor liquid separator to generate a first stream of processed liquids and a second stream of processed vapor: allowing the chilling fluid to exit the gas-to-chilling fluid heat exchanger and enter a chilling fluid reservoir; directing the chilling fluid to a refrigeration sub-system via a chilling fluid pump; wherein the refrigeration sub-system comprises an evaporator that is configured to transfer heat from the chilling fluid to a refrigerant, thereby generating vapor refrigerant: circulating the refrigerant throughout the refrigeration sub-system; routing the vapor refrigerant through a refrigeration compressor; sending the vapor refrigerant to a refrigeration condenser that is configured to transfer heat load from the warmed vapor refrigerant to atmosphere and to condense the vapor refrigerant into a liquid, thereby generating liquid refrigerant; routing the liquid refrigerant to an accumulator tank; routing the liquid refrigerant through an expansion valve that is configured to reduce temperature and pressure of the liquid refrigerant to generate reduced-pressure liquid refrigerant; routing the reduced-pressure liquid refrigerant to the evaporator; and passing at least a portion of the processed liquids to a processed liquid-to-refrigerant heat exchanger via an actuated valve controlled by a processor to remove heat from the liquid refrigerant before the liquid refrigerant is sent to the expansion valve.

In a preferred embodiment, the present invention further comprises the steps of; monitoring temperature and pressure of the refrigerant downstream of the compressor and upstream of the expansion valve via the processor; monitoring temperature of the cooled and condensed gas via the processor; wherein the compressor has a speed, adjusting the speed of the compressor in real-time via tire processor based on input from the previous steps; and wherein the refrigeration condenser has a condenser fan, adjusting the speed of the condenser fan in real-time via the processor based on input from the previous steps.

The present invention is also a method for supplementing condenser heat rejection in natural gas processing comprising the steps of: providing a stream of natural gas; directing the natural gas to a refrigeration sub-system: wherein the refrigeration sub-system comprises an evaporator that is configured to transfer heat from the natural gas to a refrigerant, thereby generating vapor refrigerant and cooled and condensed natural gas; transferring the cooled and condensed gas to a vapor liquid separator to generate a first stream of processed liquids and a second stream of processed vapor; circulating the refrigerant throughout the refrigeration sub-system; routing the vapor refrigerant through a refrigeration compressor; sending the vapor refrigerant to a refrigeration condenser that is configured to transfer heat load from the warmed vapor refrigerant to atmosphere and to condense the vapor refrigerant into a liquid, thereby generating liquid refrigerant: routing the liquid refrigerant to an accumulator tank: routing the liquid refrigerant through an expansion valve that is configured to reduce temperature and pressure of the liquid refrigerant to generate reduced-pressure liquid refrigerant; routing the reduced-pressure liquid refrigerant to the evaporator: and passing at least a portion of the processed liquids to a processed liquid-to-refrigerant heat exchanger via an actuated valve controlled by a processor to remove heal front the liquid refrigerant before the liquid refrigerant is sent to the expansion valve.

In a preferred embodiment, the present invention further comprises the steps of; monitoring temperature and pressure of the refrigerant downstream of the compressor and upstream of the expansion valve via the processor: monitoring temperature of the cooled and condensed gas via the processor; wherein the compressor has a speed, adjusting the speed of the compressor in real-time via the processor based on input from the previous steps; and wherein the refrigeration condenser has a condenser fan, adjusting the speed of the condenser fan in real-time via the processor based on input from the previous steps.

### BRIEF DESCRIPTION OF THE DRAWINGS

FIG. 1 is a flow diagram of a preferred embodiment of the present invention.

FIG. 2 is a flow diagram of a preferred embodiment of the present invention involving direct refrigeration.

FIG. 3 is a flow diagram of an alternate embodiment of the present invention.

FIG. 4 is a flow diagram of an alternate embodiment of the present invention involving direct refrigeration.

FIG. 5 is a flow diagram of the programming sequence of the present invention.

FIG. 6 is a continuation of FIG. 5.

### DETAILED DESCRIPTION OF INVENTION

A. Overview

The present invention uses a portion of the processed natural gas fluid routed to the refrigeration sub-system of the natural gas processing system, herein referred to as a slip stream. This slip stream acts as a complimenting heat transfer medium to an ambient air-to-refrigerant condenser that has limited heat rejection due to elevated ambient temperatures. The objective for NGL removal from a natural gas stream is to separate NGLs from vaporized natural gas. Once this separation has occurred, the produced liquid and vapor streams become mediums to which energy can be stored, herein referred to as energy sinks. The produced fluid energy sinks allow for a portion of the heat load to exit the natural gas processing system in one or both of these sinks. For refrigeration systems using an ambient air-to-refrigerant condenser, the ambient air temperature may reach u point at which the condenser is not rejecting the desired amount of heat for the system to operate as designed.

At this point, once the desired NGLs have been separated from the natural gas stream, a portion of the processed fluid that is at a temperature less than ambient air is crossed with the refrigerant in a heat exchanger. As explained more fully below, this step occurs downstream of the compression stage and upstream of the evaporation stage of the refrigeration cycle. The energy transferred from the refrigerant to the processed fluid is rejected as the process fluid exits the system. The energy rejected through the slip stream (which acts as an energy sink, as explained above) adds to the total heat rejection of the system as a compliment to the condenser. The total heat rejection of the system includes both the energy that is transferred to the slip stream and the energy that is transferred to ambient air via the condenser. In this manner, the present invention improves thermodynamic efficiency when the refrigeration cycle of the natural gas processing system is condenser-limited.

B. Detailed Description of the Drawings

1. Preferred Embodiment

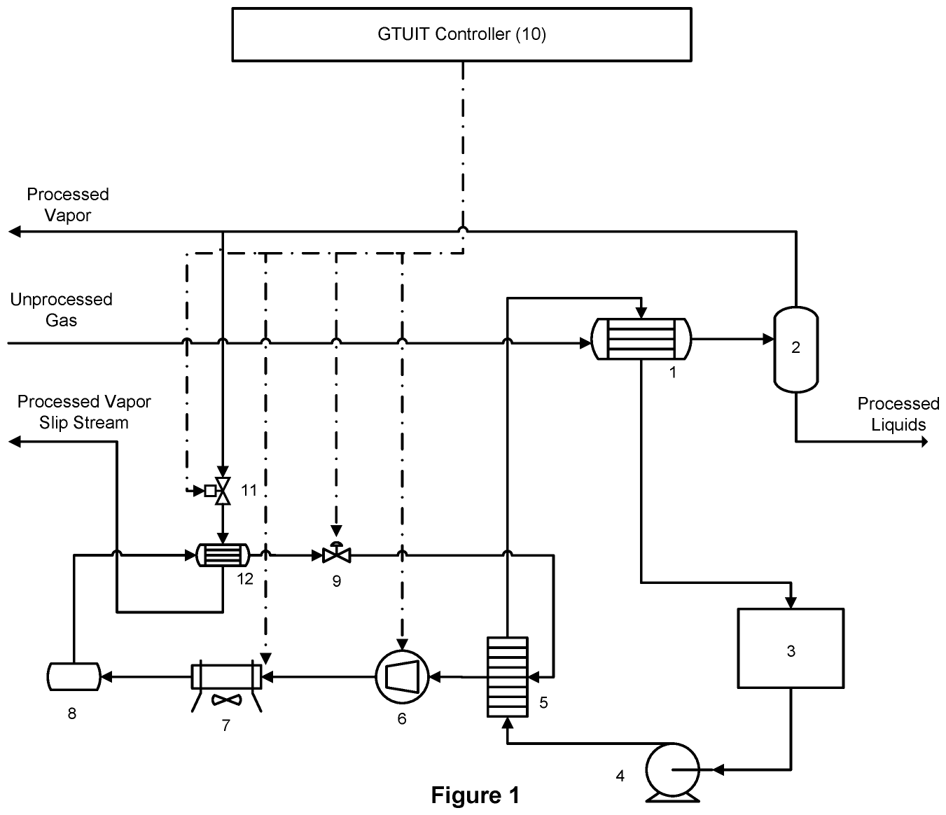

Referring to FIG. 1, unprocessed gas enters the natural gas processing system and first passes through a gas-to-chilling fluid heat exchanger (1). The heat load required to cool and condense the unprocessed gas is transferred to the chilling fluid in this heat exchanger. The cooled and condensed gas exits the gas-to-chilling fluid heat exchanger as a combination of liquid and vapor and then enters a vapor liquid separator (2). Processed liquids exit the separator as a first stream and then exit the natural gas processing system to be used or stored. Processed vapor exits the separator as a second stream (separate from the first stream) and then exits the natural gas processing system to be used or stored.

The chilling fluid exits the gas-to-chilling fluid heal exchanger (1) containing the heat load (that is, the heat load that was transferred from the gas to live chilling fluid) and then enters the chilling fluid reservoir (3). Here the chilling fluid is held in reserve to mitigate (reduce) any variations in heat load coming from the gas-to-chilling fluid heat exchanger. This occurs when the warmed chilling fluid from the gas-to-fluid heat exchanger mixes with the bulk chilling fluid in the chilling fluid reservoir, thereby averaging the temperature of the two. By averaging the temperature of the chilling fluid that enters the evaporator (5), fluctuations on the refrigeration system's cooling load are minimized.

From here (3) the chilling fluid is directed to the refrigeration sub-system via a chilling fluid pump (4). which sets the flow rate for the chilling fluid. The first component in the refrigeration sub-system is live evaporator (5). The evaporator is a heat exchanger (the second one so far in this system) that transfers heat from the chilling fluid to the refrigerant; the refrigerant circulates throughout the refrigeration sub-system, and in particular, components (5)-(9) and (12). The evaporator uses the latent heat of vaporization of the refrigerant to absorb the heat load from the chilling fluid into the refrigerant as it (the refrigerant) changes stale from a liquid to a vapor within the evaporator, thus evaporating. The vapor refrigerant is routed through the refrigeration compressor (6), where the refrigerant pressure is increased (still in vapor form) and then sent to the refrigeration condenser (7). The refrigeration condenser, which is the third heat exchanger in the system, uses fans that blow air across fins containing the refrigerant to transfer the heat load from the vapor refrigerant to the atmosphere anything outside of the system), at the same time condensing the vapor refrigerant into a liquid. Next, the liquid refrigerant is routed to an accumulator tank (8) (via the processed vapor-to-refrigerant heat exchanger discussed in the next paragraph) and then through an expansion valve (9), which reduces the temperature and pressure of the liquid refrigerant. The reduced-pressure liquid refrigerant is then routed back to the evaporator, completing the cycle.

If increased heat rejection is called for by the processor (10) (for example, due to condenser limitations as a result of high ambient temperatures), an actuated valve (11) is opened to allow a portion of the processed vapor stream (also referred to as the “processed vapor slip stream”) from the vapor liquid separator (2) to cross with refrigerant in a fourth heat exchanger (12) (referred to herein as the processed vapor-to-refrigerant heat exchanger) and further remove heat from the refrigerant before it reaches the expansion valve (9).

The processed vapor-to-refrigerant heat exchanger (12) is located downstream of the compressor (6) and upstream of the expansion valve (9). After the refrigerant leaves this heat exchanger (12), it enters the expansion valve (9) to complete the refrigeration cycle. The processed vapor slip stream leaves this heat exchanger containing a portion of the heat load from the refrigerant and then exits the natural gas processing system. The processor monitors the temperature and pressure of the refrigerant downstream of the compressor and upstream of the expansion valve, as well as the speed of the compressor and condenser fan and the temperature of the natural gas, to maintain the steady operation of the equipment. The processor (10) may be either a programmable logic controller (PLC) or a programmable automation controller (PAC).

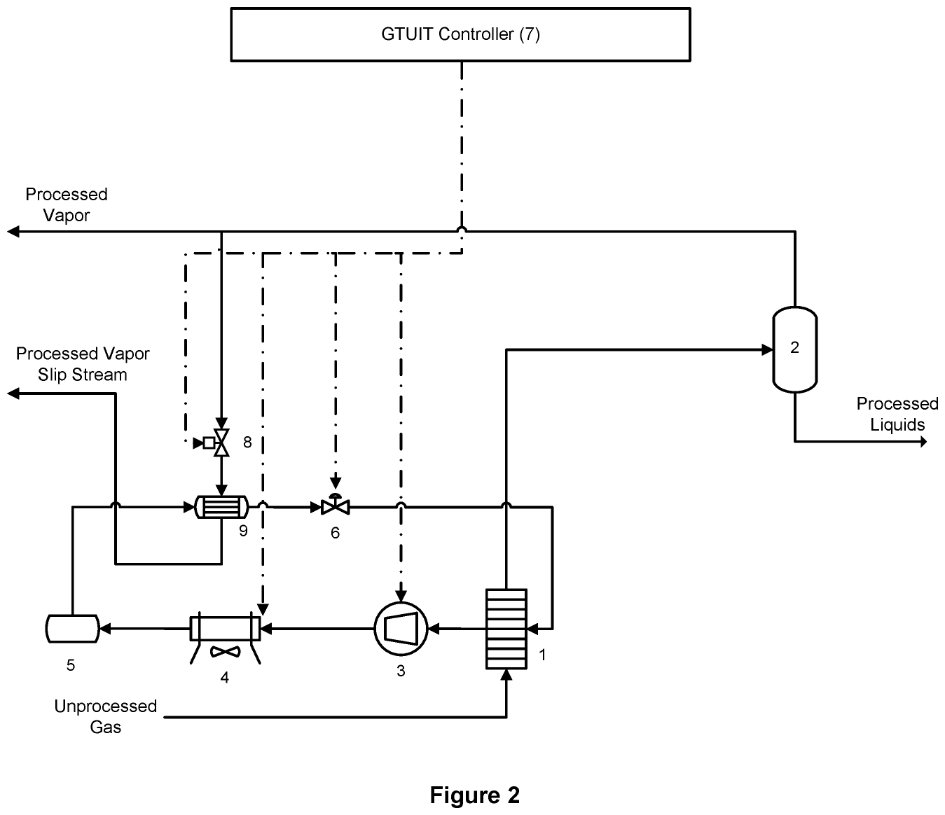

The present invention can also be applied to a direct refrigeration system as shown in FIG. 2. In a direct refrigeration system, the natural gas to be cooled is crossed with the refrigerant in the evaporator (1). The evaporator is a heat exchanger that transfers heat from the natural gas to the refrigerant; the refrigerant circulates throughout the refrigeration sub-system, and in particular, components (1), (3)-(6) and (9). The evaporator uses the latent heat of vaporization of the refrigerant to absorb the heat load from the natural gas into the refrigerant as it (the refrigerant) changes stale from a liquid to a vapor within the evaporator, thus evaporating. The vapor refrigerant is routed through the refrigeration compressor (3), where the refrigerant pressure is increased (still in vapor form) and then sent to the refrigeration condenser (4). T he refrigeration condenser, which is the second heat exchanger in the system, uses fans that blow air across fin* containing the refrigerant to transfer the hear load from the vapor refrigerant to the atmosphere (i.e., anything outside of the system), at the same time condensing the vapor refrigerant into a liquid. Next, the liquid refrigerant is routed to an accumulator tank (5) (via the processed vapor-to-refrigerant heat exchanger discussed in the next paragraph) and then through on expansion valve (6), which reduces the temperature and pressure of the liquid refrigerant. The pressure liquid refrigerant is then routed back to the evaporator, completing the cycle.

If increased heat rejection is called for by the processor (7) (for example, due to condenser limitations as a result of high ambient temperatures), an actuated valve (8) is opened to allow a portion of the processed vapor stream (also referred to as the “processed vapor slip stream”) from the vapor liquid separator (2) to cross with refrigerant in a third heat exchanger (9) (referred to herein as the processed vapor-to-refrigerant beat exchanger) and further remove heat from the refrigerant before it reaches the expansion valve (9).

The processed vapor-to-refrigerant heat exchanger (9) is located downstream of the compressor (3) and upstream of the expansion valve (6). After the refrigerant leaves this heat exchanger (9), it enters the expansion valve (6) to complete the refrigeration cycle. The processed vapor slip stream leaves this heat exchanger containing a portion of the heat load from the refrigerant and then exits the natural gas processing system. The processor monitors the temperature and pressure of the refrigerant downstream of the compressor and upstream of the expansion valve as well as the speed of the compressor and condenser fan and the temperature of the natural gas to maintain the steady operation of the equipment. The processor (7) may be either a programmable logic controller (PLC) or a programmable automation controller (PAC).

2. Alternate Embodiment

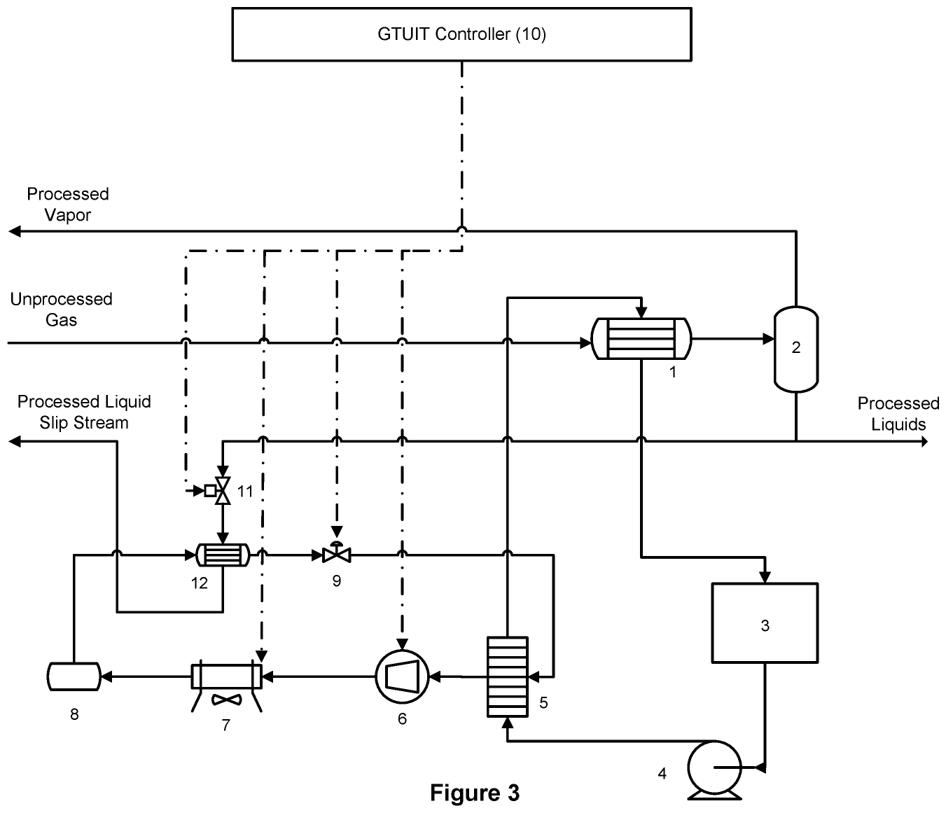

Referring to FIG. 3, unprocessed gas enters the natural gas processing system and first passes through a gas-to-chilling fluid heat exchanger (1). The heat load required to cool and condense the unprocessed gas it transferred to the chilling fluid in this heat exchanger. The cooled and condensed gas exits the gas-to-chilling fluid heat exchanger as a combination of liquid and vapor and then enters a vapor liquid separator (2). Processed liquids exit the separator as a first stream and then exit the natural gas processing system to be used or stored. Processed vapor exits the separator as a second stream (separate from the first stream) and then exits the natural gas processing system to he used or stored.

The chilling fluid exits the gas-to-chilling fluid heat exchanger (1) containing the heat load (that is, the heat load that was transferred from the gas to the chilling fluid) and then enters the chilling fluid reservoir (3). Here the chilling fluid is held in reserve to mitigate (reduce) any variations in heat load coming from the gas-to-chilling fluid heat exchanger. This occurs when the warmed chilling fluid from the gas-to-fluid heat exchanger mixes with the bulk chilling fluid in the chilling fluid reservoir, thereby averaging the temperature of the two. By averaging the temperature of the chilling fluid that enters the evaporator (5), fluctuations on the refrigeration system's cooling load are minimized.

From here (3) the chilling fluid is directed to the refrigeration sub-system via a chilling fluid pump (4). which sets the flow rate for the chilling fluid. The first component in the refrigeration sub-system is the evaporator (5). The evaporator is a heat exchanger (the second one so far in this system) that transfers heat from the chilling fluid to the refrigerant; the refrigerant circulates throughout the refrigeration sub-system, and in particular, components (5)-(9) and (12). The evaporator uses the latent heat of vaporization of the refrigerant to absorb the heat load from the chilling fluid into the refrigerant as it (the refrigerant) changes state from a liquid to a vapor within the evaporator, thus evaporating. The vapor refrigerant is routed through the refrigeration compressor (6), where the refrigerant pressure is increased (still in vapor form) and then sent to the refrigeration condenser (7). The refrigeration condenser, which is the third heat exchanger in the system, uses fans that blow air across fins containing the refrigerant to transfer the heat load from the vapor refrigerant to the atmosphere (i.e., anything outside of the system), at the same time condensing the vapor refrigerant into a liquid. Next, the liquid refrigerant is routed to an accumulator tank (8) (via the processed vapor-to-refrigerant heat exchanger discussed in the next paragraph) and then through an expansion valve (9), which reduces the temperature and pressure of the liquid refrigerant. The reduced-pressure liquid refrigerant is then muted back to the evaporator, completing the cycle.

If increased heat rejection is called for by the processor (10) (for example, due to condenser limitations as a result of high ambient temperatures), an actuated valve (11) is opened to allow a portion of the processed liquid stream (also referred to as the “processed liquid slip stream”) from the vapor liquid separator (2) to cross with refrigerant in a fourth heat exchanger (12) (referred to herein as the processed liquid-to-refrigerant heat exchanger) and further remove heat from the refrigerant before it reaches the expansion valve (9).

The processed liquid-to-refrigerant heat exchanger (12) is located downstream of the compressor (6) and upstream of the expansion valve (9). After the refrigerant leaves this heat exchanger (12), it enters the expansion valve (9) to complete the refrigeration cycle. The processed liquid slip stream leaves this heat exchanger containing a portion of the heat load from the refrigerant and then exits the natural gas processing system. The processor monitors the temperature and pressure of the refrigerant downstream of the compressor and upstream of the expansion valve as well as the speed of the compressor and condenser fan and the temperature of the natural gas to maintain the steady operation of the equipment. The processor (10) may be either a programmable logic controller (PLC) or a programmable automation controller (PAC).

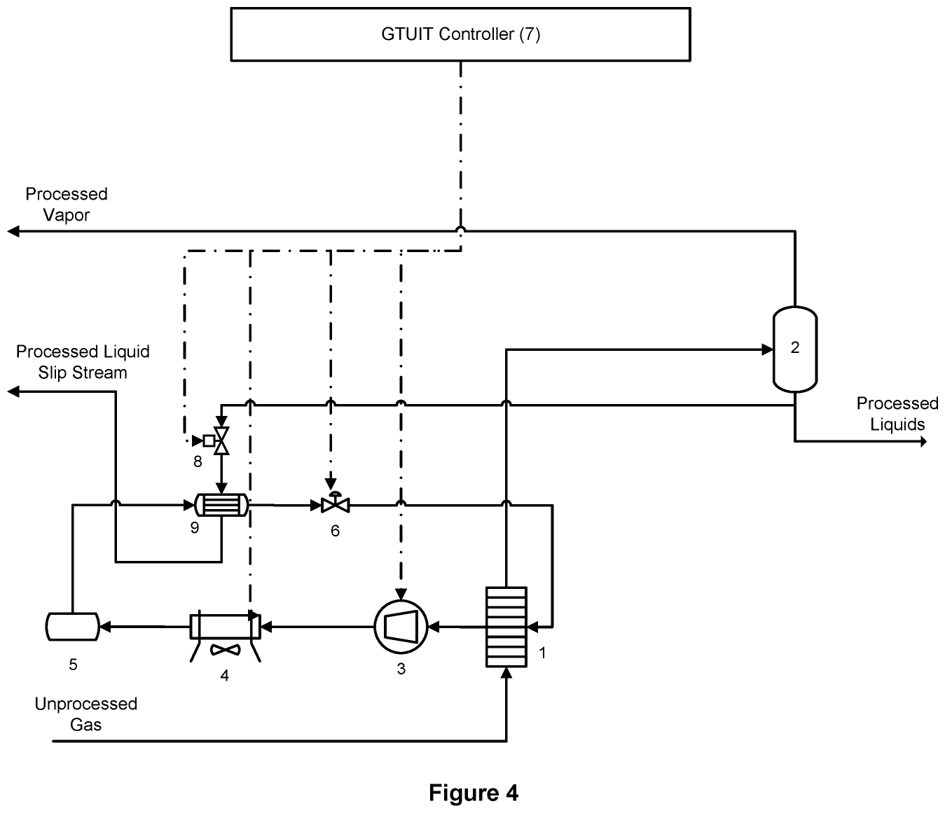

The present invention can also be applied to a direct refrigeration system as shown in FIG. 4. In a direct refrigeration system, the natural gas to be cooled is crossed with the refrigerant in the evaporator (1). The evaporator is a heal exchanger that transfers heat from the natural gas to the refrigerant; the refrigerant circulates throughout the refrigeration sub-system, and in particular, components (1), (3)-(6) and (9). The evaporator uses the latent heat of vaporization of the refrigerant to absorb the heat load from the natural gas into the refrigerant as it (the refrigerant) changes state front a liquid to a vapor within the evaporator, thus evaporating. The vapor refrigerant ts routed through the refrigeration compressor (3), where the refrigerant pressure is increased (still in vapor form) and then sent to the refrigeration condenser (4). The refrigeration condenser, which is the second heat exchanger in the system, uses fans that blow air across fins containing the refrigerant to transfer the heat load from the vapor refrigerant to the atmosphere (i.e., anything outside of the system), at the same time condensing the vapor refrigerant into a liquid. Next, the liquid refrigerant is routed to an accumulator tank (5) (via the processed vapor-to-refrigerant hear exchanger discussed in the next paragraph) and then through an expansion valve (6), which reduces the temperature and pressure of the liquid refrigerant. The reduced-pressure liquid refrigerant is then routed back to the evaporator, completing the cycle.

If increased heat rejection is called for by the processor (7) (for example, due to condenser limitations as a result of high ambient temperatures), an actuated valve (8) is opened to allow a portion of the processed liquid stream (also referred to as the “processed liquid slip stream”) from the vapor liquid separator (2) to cross with refrigerant in a third heat exchanger (9) (referred to herein as the processed liquid-to-refrigerant heat exchanger) and further remove heat from the refrigerant before it reaches the expansion valve (9).

The processed liquid-to-refrigerant heat exchanger (9) is located downstream of the compressor (3) and upstream of the expansion valve (6). After the refrigerant leaves this heat exchanger (9), it enters the expansion valve (6) to complete the refrigeration cycle. The processed liquid slip stream leaves this heat exchanger containing a portion of the heat load from the refrigerant and then exits the natural gas processing system. The processor monitors the temperature and pressure of the refrigerant downstream of the compressor and upstream of the expansion valve as well as the speed of the compressor and condenser fan and the temperature of the natural gas to maintain the steady operation of the equipment. The processor (7) may be either a programmable logic controller (PLC) or a programmable automation controller (PAC).

3. Software

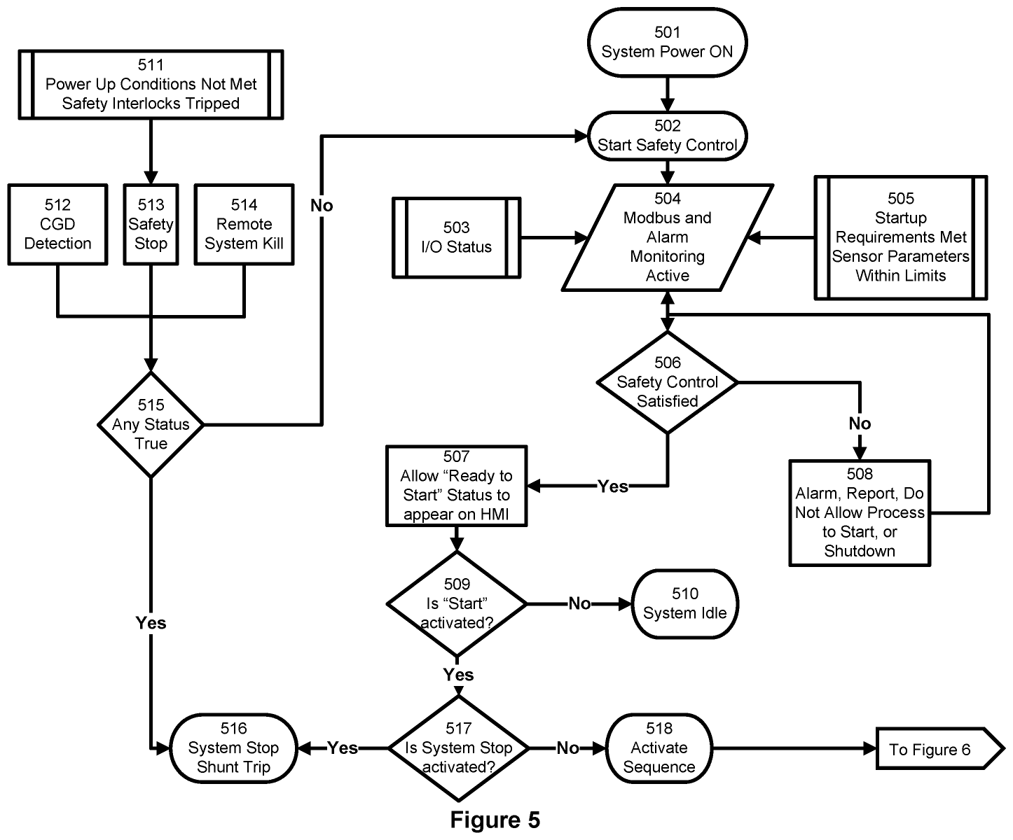

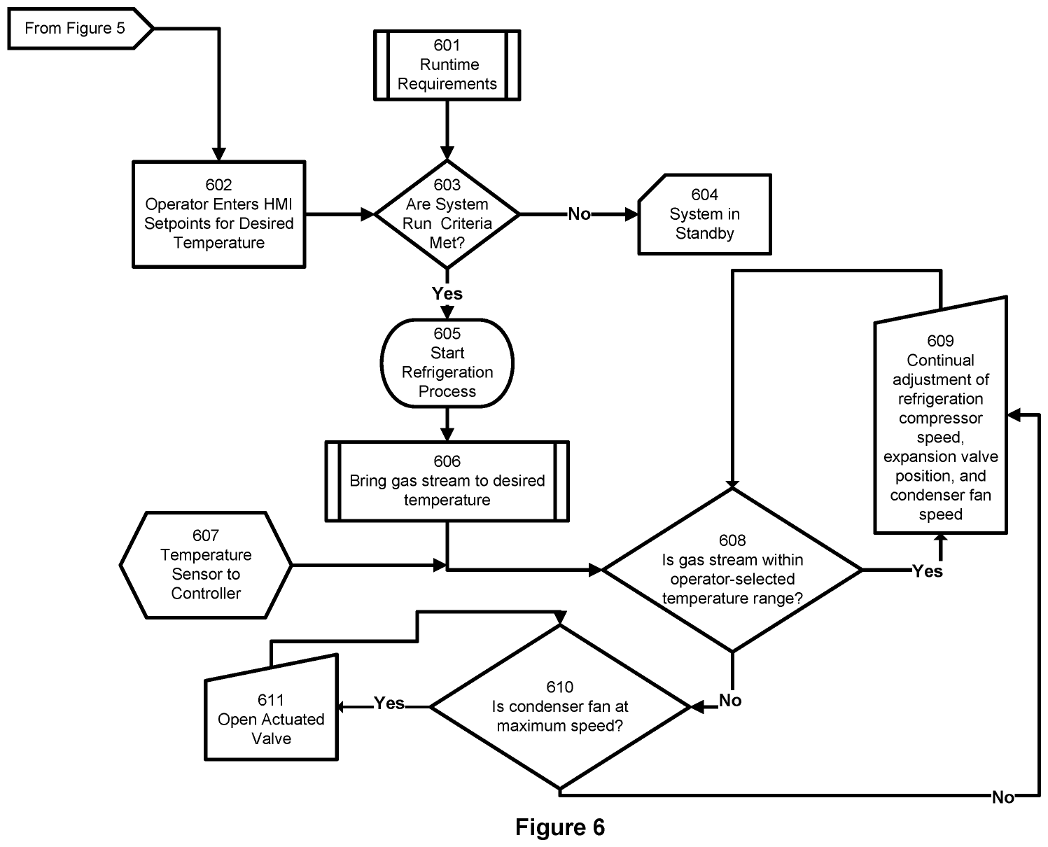

FIGS. 5 and 6 are flow diagrams of the programming sequence of the present invention. As shown in FIG. 5, when initial power is applied, the controller begins the Boot-Up process 501. The controller then initializes the monitor for correct configuration and begins checking safely stop interlocks, combustible gas detection (GCD). and remote modbus values. If all initial values are within allowed parameters, the controller allows system startup 502. Both analog and digital inputs and outputs used for control and operational decisions are used by the controller. Discrete switch positions, analog temperatures, valve positions, and pressures are monitored by the controller 503. The controller continually monitors conditions to ensure ongoing safe operation 504. At step 505, the controller assesses whether start-up requirements have been met based on both operator input (for example, as to system configuration and parameters for high and low limits) and sensor parameters (for example, regarding the state of the system).

As long as the safety control 506 is satisfied, the “Ready to Start” icon will appear on the human-machine interface (HMI) 507. The system can stay in this mode indefinitely until the start icon is toggled. If at any time the safety status is no longer satisfied, the “Ready to Start” icon disappears, and the alternate path 508 is invoked until the issues are cleared 506. In the event that the safely control is no longer satisfied, alarms are generated, and a report is cued for send out to the remote monitoring network. An inhibit is also led back into the process to prevent startup, continued operation, or system shutdown if the alarm merits 508. If just an inhibit is necessary, the controller monitors the status of the “Ready to Start” bit 509.

If the system is ready to run (i.e., the “Ready to Start” icon appears), but the “Ready to Start” icon has not been pressed, the process will remain in “idle” mode indefinitely 510. Hardware safety interlocks must be satisfied to allow power to be applied to the system. This includes level switches, emergency stop push-button switches, and lock out/tag out switches 511. A combustible gas detection (CGD) sensor is located in the same physical electrical enclosure as the controller; this enclosure is separate and apart from the system described above. The CGD sensor monitors for a threshold of 20% or greater of the lower explosive limit (LEL) to send a shutdown notice 512. Any of the safety interlocks from box 513 that fail will send a shutdown notice 516 to the controller, which then initiates the shutdown process. The remote telemetry service (i.e., satellite connection) is also capable of sending a shutdown notice 514 to the controller. If one of these inputs 512, 513, 514 shows a fault in startup 515, the controller sends a signal to shunt trip the main breaker to shut down the system 516. These three inputs are monitored by the controller whenever the system is in operation. The controller also monitors the system stop button 517. At any time, if the system stop 517 is pressed after a start command has been initiated, the controller sends a signal to shunt trip the main breaker to shut down the system after a sequential stop on running subsystems. If the start command has been initiated 509, and there are no faults in startup, the sequence to transition from startup to raw gas conditioning 518 is activated.

As shown in FIG. 6, there are additional criteria that must be met beyond the startup requirements in order for the system to proceed past the “idle” or “standby” state. These criteria include reservoir oil, compressor temperature, or pressures 601. These values may not necessitate a system shutdown, but they may require suspension of system operation until the values are within an acceptable range. On the HML the operator will input the required parameters and set points specific to the wellsite, including, but not limited to, temperature of the chilling fluid 602.

As noted in the preceding paragraph, a preconfigured list of runtime requirements must be met before starling the process 603. The system can stay in standby mode waiting for values to come into compliance with requirements 604. When all requirements—both startup (see FIG. 5) and runtime 601—are met. the controller will activate the compressor and start the refrigeration process 605 to bring the gas stream to the desired temperature via the refrigeration cycle. A sensor reads the gas temperature and transmits that data to the controller to ensure that gas reaches the setpoint temperature 607. The controller then continually monitors the process temperature to determine whether it is withing the programmed range 608. In order to ensure that it stays within this range, the processor will adjust the refrigeration compressor speed, expansion valve position, and condenser fan speed 609. If the processor determines that the gas stream is not within the specified range, the speed of the fan will be verified to confirm that it is at maximum speed 610. If the fan is at maximum speed, and the desired temperature is not met. the actuated valve for the vapor or liquid slip stream will be opened. If the condenser fan is not at maximum speed, the processor returns to 609.

C. Advantage of the Present Invention Over Prior Art

In traditional applications of refrigeration, the desired outcome is to cool and maintain a cold temperature of the processed fluid. As a result, traditional applications of refrigeration cannot use the processed fluid to reject heat out of the system control volume. The conventional method for mitigating ambient air-to-refrigerant condenser limitation is either to increase the size of the condenser or to reduce the temperature of the air entering the condenser with an auxiliary refrigeration system. Increasing the size of the condenser increases the footprint of the system and is often not a viable option due to footprint constraints. Using an auxiliary refrigeration system to pre-cool air entering the condenser can be expensive, complex, and may lose efficiency at elevated ambient temperatures.

The desired outcome for NGL removal from a natural gas stream is the separation of heavy hydrocarbon liquids from natural gas vapor. Once this occurs, the processed fluid streams can be used as energy sinks for heat rejection. The present invention takes advantage of the processed natural gas fluids to compliment the heat rejection provided by the condenser that is limited by elevated ambient air temperatures. By transferring a portion of the heat load to the processed fluids, inefficiencies caused by condenser limitations are reduced without increasing the footprint size of the system or adding an auxiliary refrigeration system.

Although the preferred embodiment of the present invention has been shown and described, it will be apparent to those skilled in the art that many changes and modifications may be made without departing from the invention in its broader aspects. The appended claims are therefore intended to coverall such changes and modifications as fall within the true spirit and scope of the invention.

We claim:

1. A method for supplementing condenser heat rejection in natural gas processing comprising the steps of:
(a) passing unprocessed gas through a gas-to-chilling fluid heat exchanger to generate cooled and condensed gas, wherein the gas-to-chilling fluid heat exchanger contains chilling fluid;
(b) transferring the cooled and condensed gas to a vapor liquid separator to generate a first stream of processed liquids and a second stream of processed vapor;
(c) allowing the chilling fluid to exit the gas-to-chilling fluid heat exchanger and enter a chilling fluid reservoir;
(d) directing the chilling fluid to a refrigeration sub-system via a chilling fluid pump;
wherein the refrigeration sub-system comprises an evaporator that is configured to transfer heat from the chilling fluid to a refrigerant thereby generating vapor refrigerant;
(e) circulating the refrigerant throughout the refrigeration sub-system;
(f) routing the vapor refrigerant through a refrigeration compressor:
(g) sending the vapor refrigerant to a refrigeration condenser that is configured to transfer heal load from the vapor refrigerant to atmosphere and to condense the vapor refrigerant into a liquid, thereby generating liquid refrigerant;
(h) routing the liquid refrigerant to an accumulator tank;
(i) routing the liquid refrigerant through an expansion valve that is configured to reduce temperature and pressure of the liquid refrigerant to generate reduced-pressure liquid refrigerant;
(j) routing the reduced-pressure liquid refrigerant to the evaporator; and
(k) passing at least a portion of the processed vapor to a processed vapor-to-refrigerant heat exchanger via an actuated valve controlled by a processor to remove heat from the liquid refrigerant before the liquid refrigerant is sent to the expansion valve.

2. The method of claim 1, further comprising the steps of:
(l) monitoring temperature and pressure of the refrigerant downstream of the compressor and upstream of the expansion valve via the processor;
(m) monitoring temperature of the cooled and condensed gas via the processor;
(n) wherein the compressor has a speed, adjusting the speed of the compressor in real-time via the processor based on input from steps (l) and (m); and
(o) wherein the refrigeration condenser has a condenser fan, adjusting the speed of the condenser fan in real-time via the processor based on input from steps (l) and (m).

3. A method for supplementing condenser heat rejection in natural gas processing comprising the steps of:
(a) providing a stream of natural gas;
(b) directing the natural gas to a refrigeration sub-system;
wherein the refrigeration sub-system comprises an evaporator that is configured to transfer heat from the natural gas to a refrigerant, thereby generating vapor refrigerant and cooled and condensed natural gas;
(b) transferring the cooled and condensed gas to a vapor liquid separator to generate a first stream of processed liquids and a second stream of processed vapor;
(c) circulating the refrigerant throughout the refrigeration sub-system;
(d) routing the vapor refrigerant through a refrigeration compressor;
(e) sending the vapor refrigerant to a refrigeration condenser that is configured to transfer heat load from live vapor refrigerant to atmosphere and to condense the vapor refrigerant into a liquid, thereby generating liquid refrigerant;
(f) routing the liquid refrigerant to an accumulator tank;
(g) routing the liquid refrigerant through an expansion valve that is configured to reduce temperature and pressure of the liquid refrigerant to generate reduced-pressure liquid refrigerant;
(h) routing the reduced-pressure liquid refrigerant to the evaporator; and
(i) passing at least a portion of the processed vapor via an actuated valve controlled by a processor to a processed vapor-to-refrigerant heat exchanger to remove heat from the liquid refrigerant before the liquid refrigerant is sent to the expansion valve.

4. The method of claim 3, further comprising the steps of:
(j) monitoring temperature and pressure of the refrigerant downstream of the compressor and upstream of the expansion valve via the processor;
(k) monitoring temperature of the cooled and condensed gas via the processor;
(l) wherein the compressor has a speed, adjusting the speed of the compressor in real-time via the processor based on input from steps (j) and (k); and
(m) wherein the refrigeration condenser has a condenser fan, adjusting the speed of the condenser fan in real-time via the processor based on input from steps (j) and (k).

5. A method for supplementing condenser heat rejection in natural gas processing comprising the steps of:
(a) passing unprocessed gas through a gas-to-chilling fluid heat exchanger to generate cooled and condensed gas, wherein the gas-to-chilling fluid heat exchanger contains chilling fluid;
(b) transferring the cooled and condensed gas to a vapor liquid separator to generate a first stream of processed liquids and a second stream of processed vapor;
(c) allowing the chilling fluid to exit the gas-to-chilling fluid heat exchanger and enter a chilling fluid reservoir;
(d) directing the chilling fluid to a refrigeration sub-system via a chilling fluid pump:
wherein the refrigeration sub-system comprises an evaporator that is configured to transfer heat from the chilling fluid to a refrigerant, thereby generating vapor refrigerant:
(e) circulating the refrigerant throughout the refrigeration sub-system;
(f) routing the vapor refrigerant through a refrigeration compressor;
(g) sending the vapor refrigerant to a refrigeration condenser that is configured to transfer heat load from the warmed vapor refrigerant to atmosphere and to condense the vapor refrigerant into a liquid, thereby generating liquid refrigerant;
(h) routing the liquid refrigerant to an accumulator tank;
(i) routing the liquid refrigerant through an expansion valve that is configured to reduce temperature and pressure of the liquid refrigerant to generate reduced-pressure liquid refrigerant;
(j) routing the reduced-pressure liquid refrigerant to the evaporator; and
(k) passing at least a portion of the processed liquids to a processed liquid-to-refrigerant heat exchanger via an actuated valve controlled by a processor to remove heat from the liquid refrigerant before the liquid refrigerant is sent to the expansion valve.

6. The method of claim 1, further comprising the steps of:
(l) monitoring temperature and pressure of the refrigerant downstream of the compressor and upstream of the expansion valve via the processor;
(m) monitoring temperature of the cooled and condensed gas via the processor;
(n) wherein the compressor has a speed, adjusting the speed of the compressor in real-time via the processor based on input from steps (l) and (m); and
(o) wherein the refrigeration condenser has a condenser fan, adjusting the speed of the condenser fan in real time via the processor based on input from steps (l) and (m).

7. A method for supplementing condenser heat rejection in natural gas processing comprising the steps of:
(a) providing a stream of natural gas;
(b) directing the natural gas to a refrigeration sub-system;
wherein the refrigeration sub-system comprises an evaporator that is configured to transfer heat from the natural gas to a refrigerant, thereby generating vapor refrigerant and cooled and condensed natural gas:
(b) transferring the cooled arid condensed gas to a vapor liquid separator to generate a first stream of processed liquids and a second stream of processed vapor;
(c) circulating the refrigerant throughout the refrigeration sub-system;
(d) routing the vapor refrigerant through a refrigeration compressor;
(e) sending the vapor refrigerant to a refrigeration condenser that is configured to transfer heat load from the warmed vapor refrigerant to atmosphere and to condense the vapor refrigerant into a liquid, thereby generating liquid refrigerant:
(f) routing the liquid refrigerant to an accumulator tank;
(g) routing the liquid refrigerant through an expansion valve that is configured to reduce temperature and pressure of the liquid refrigerant to generate reduced-pressure liquid refrigerant;
(h) routing the reduced-pressure liquid refrigerant to the evaporator; and
(i) passing at least a portion of the processed liquids to a processed liquid-to-refrigerant heat exchanger via an actuated valve controlled by a processor to remove heat from the liquid refrigerant before the liquid refrigerant is sent to the expansion valve.

8. The method of claim 3, further comprising the steps of:
(j) monitoring temperature and pressure of the refrigerant downstream of the compressor and upstream of the expansion valve via the processor;
(k) monitoring temperature of the cooled and condensed gas via the processor;
(l) wherein the compressor has a speed, adjusting the speed of the compressor in real-time via the processor based on input from steps (j) and (k); and
(m) wherein the refrigeration condenser has a condenser fan, adjusting the speed of the condenser tan in real-time via the processor based on input from steps (j) and (k).
